(19) United States
(12) Patent Application Publication
(10) Pub. No.: US 2020/0062557 A1
(43) Pub. Date: Feb. 27, 2020

(54) STACKING BLOCK FOR LATTICE BOOM CRANE

(71) Applicant: Matthew Roy Hill, Evansville, IN (US)

(72) Inventor: Matthew Roy Hill, Evansville, IN (US)

(21) Appl. No.: 16/550,822

(22) Filed: Aug. 26, 2019

Related U.S. Application Data
(60) Provisional application No. 62/723,204, filed on Aug. 27, 2018.

(51) Int. Cl. B66C 23/70

(52) U.S. Cl. CPC B66C 23/70

(57) ABSTRACT

A stacking block for supporting one or more lattice boom crane elements in a stacked storage condition. The stacking block may be formed of a lightweight plastic or resilient material that can easily be lifted overhead. The stacking block provides the space needed in between boom elements in order to safely stack the elements on a ground surface or on top of one another, without damaging parts.

### CROSS-REFERENCE TO RELATED APPLICATION

This application claims the benefit of priority of U.S. provisional application No. 62/723,204, filed Aug. 27, 2018, the contents of which are herein incorporated by reference.

### BACKGROUND OF THE INVENTION

The present invention relates to lattice boom cranes, and more particularly to apparatus and methods for storage of lattice boom sections.

Presently, the problem is wasted space in storage yards as well as job sites. Lattice boom sections take up valuable space during assembly and disassembly. The current method uses solid, heavy wood and is not feasible with some manufacturer's boom designs.

If wood is used, multiple workers must place and remove large blocks, wasting time and energy. Moreover, in some applications wood does not work because of damage to crane components.

As can be seen, there is a need for a lightweight plastic product that can easily be lifted overhead that provides the space needed in between pieces of boom in order to safely stack the crane elements on top of one another without damaging the crane elements.

### SUMMARY OF THE INVENTION

In one aspect of the present invention, a stacking block assembly for supporting a lattice boom element of a lattice boom crane is disclosed. The stacking block assembly includes a body formed of a material selected from the group consisting of a plastic, a composite; an elastomer, or a rubber. A first arcuate channel is defined in a bottom surface of the body along a longitudinal length thereof. A second arcuate channel is defined in a top surface of the body along a longitudinal length thereof.

The first arcuate channel may have a diameter corresponding to a diameter of a vertical support member of a subjacent lattice boom element. The second arcuate channel may have a diameter corresponding to a diameter of a vertical support member of a superjacent lattice boom element.

In some embodiments, a hole extends transversely through the body between the first arcuate channel and the second arcuate channel.

In other embodiments an elongate rod having a length corresponding to a width of the lattice boom element is provide. The elongate rod is received through the hole; of a first body and a second body that are carried in a spaced apart relation on the elongate bar corresponding to the width of the lattice boom element.

In yet other embodiments, a cradle cable extends at a proximal end from each of a first end and a second end of the elongate rod. A yoke may be attached to a distal end of the cradle cable.

Other aspects of the invention include a method of supporting a lattice boom element of a lattice boom crane. The method includes providing a stacking block, having a body formed of a material selected from the group consisting of a plastic, a composite; an elastomer, or a rubber. A first arcuate channel is defined in a bottom surface of the body along a longitudinal length thereof. A second arcuate channel is defined in a top surface of the body along a longitudinal length thereof. A lower vertical support member of the lattice boom element is received in the second arcuate channel.

In some embodiments, the method includes supporting a bottom surface of the stacking block on a ground surface.

In other embodiments of the method, an upper vertical support member of a subjacent lattice boom element is received in the first arcuate channel. A strap may be applied to strap the lattice boom element and the subjacent lattice boom element together.

These and other features, aspects and advantages of the present invention will become better understood with reference to the following drawings, description and claims.

### BRIEF DESCRIPTION OF THE DRAWINGS

FIG. 1 is an exploded front elevation view of the lattice boom stacking blocks positioned between two lattice boom components;

FIG. 2 is a side elevation of the stacking blocks in use between two lattice boom components; and

FIG. 3 is view of the stacking blocks arranged in a lifting cradle assembly.

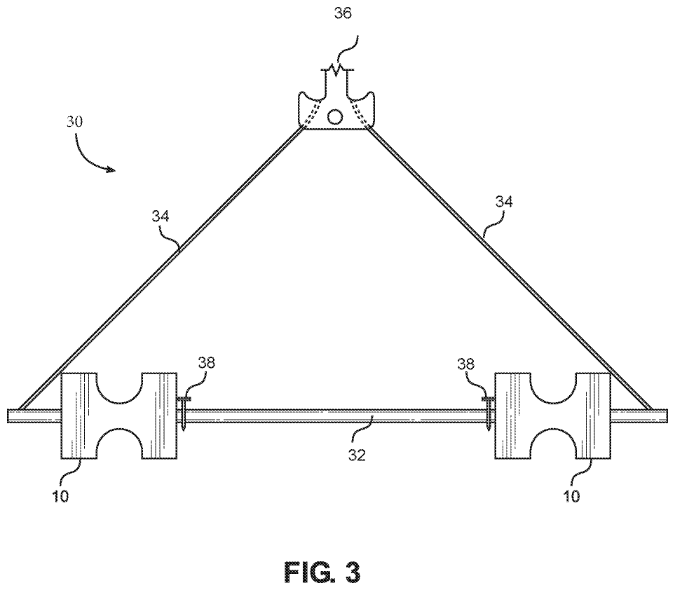

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a stacking block and method of employing the same for the stacked storage of lattice boom crane elements.

As stated above, the problem with lattice boom crane storage is wasted space at either the storage yards or the job sites. Lattice boom sections take up valuable space during both assembly and disassembly of the crane. The invention claimed here solves this problem. The stacking block and present invention allows for easy stacking of boom sections of a lattice boom crane without the use of heavy wood. Wood shoring is impractical in many situations causing damage to the crane lacing and pendants. It is also heavy and difficult to manipulate into position by a user.

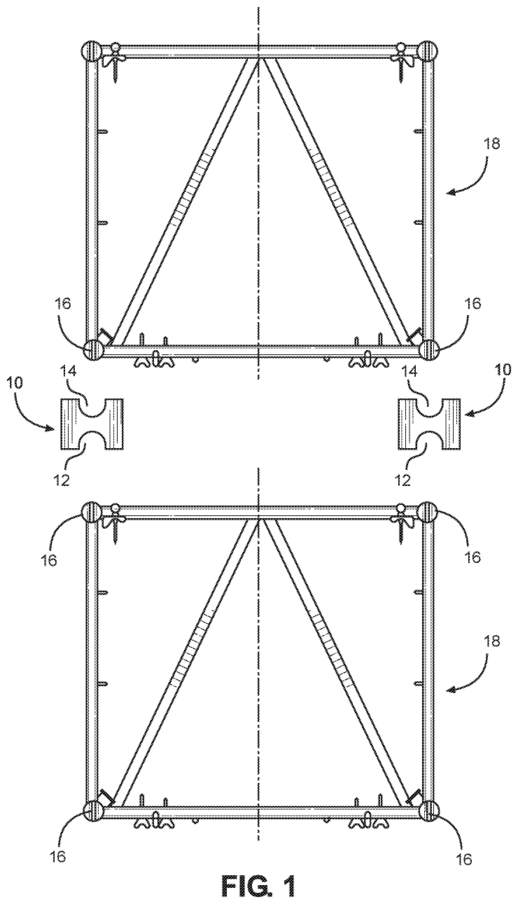

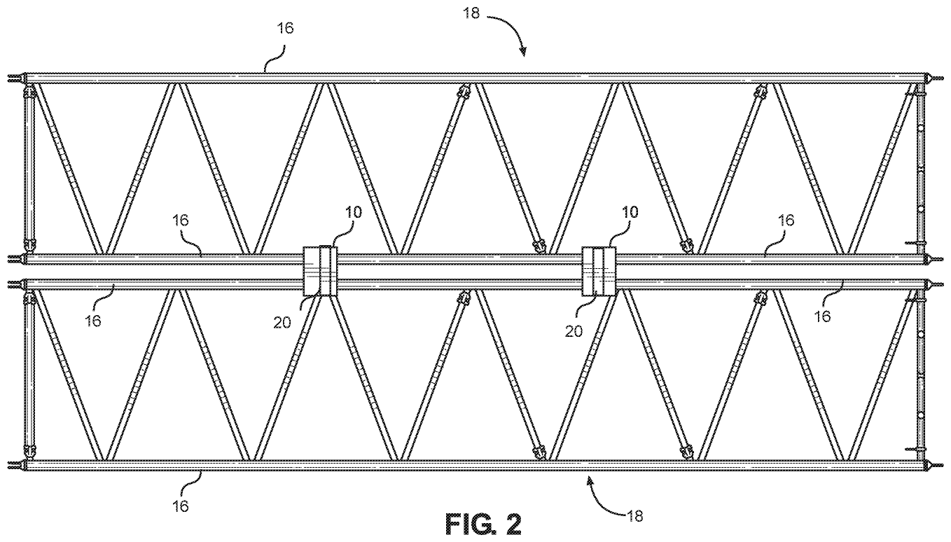

As seen in reference to FIGS. 1 and 2, a stacking block 10 according to aspects of the present invention includes a body 10 which may be formed as a lightweight plastic, a composite, an elastomeric, or a rubberized block that can easily be lifted overhead. The stacking block 10 has a first arcuate channel 12 defined along a bottom surface of the stacking block 10 and a second arcuate channel 14 defined along an opposed top surface of the stacking block 10. The first and second arcuate channels 12, 14 have a radius corresponding to that of a tubular longitudinal support member 16 of the lattice boom crane element 18. The stacking block 10 has a vertical thickness defined so that first arcuate channel 12 and the second arcuate channel 14 provide a desired vertical clearance between adjacent boom elements 18, such that the boom elements 18 are maintained in a spaced apart relation when stacked, in order to safely stack the crane elements 18 on top of one another without damaging parts. The stacking block 10 may be molded out of recycled plastic, rubber, or other resilient material, at specific dimensions to precisely fit crane lattice boom 18.

In use, the stacking blocks 10 may be used in a group of four or more. The stacking blocks 10 are positioned to separate the lattice boom crane elements 18 by the desired distance allowing the sections 18 to be stacked. The stacking block 10 is placed to position on a top support frame element of a lower crane boom element 18′ within the first arcuate channel 12. An additional crane boom element 18 is lifted and placed on top of the stacking block 10 so that a lower support frame member 16 is received in the second arcuate channel 14. As will be appreciated with the benefit of applicant's disclosure, the stacking block 10 could also be used for stacking various types of pipe.

Once the crane elements 18 have been placed and stacked on the stacking blocks 10, the addition of rigid or flexible bands 20, more preferably ratcheting straps, may be used in some applications to retain or strap the boom elements 18 together to provide added stability and permit lifting and movement of the stacked boom elements 18 as a unit. As indicated previously, the stacking blocks 10 may vary in size depending on crane manufacturer, capacity, and the dimensions of the lattice boom elements. The first arcuate channel 12 may also have a different diameter than that of the second arcuate channel 14 where the respective support frame member 16 of the lattice boom 18 are dissimilar.

The stacking blocks 10 may be used individually as basic cribbing to keep crane boom sections 18 an elevated position above the ground. When space is limited the boom sections 18 can be stacked on top of one another as previously described.

In other aspects of the invention, a stacking block lifting cradle 30 is also disclosed. The lifting cradle 30 includes an elongate bar 32 that has a length at least as wide as the lattice boom elements 18 to be supported by the lifting cradle 30. A cradle cable 34 extends from each of a first end and a second end of the elongate bar 32. The lifting cradle 30 may also include a lifting yoke 36 for connection of each of the cradle cable 34. Alternatively, each cradle cable 34 may have a loop at an end thereof for connection to an associated hook on the lifting yoke 36.

A stacking block 10 may be carried on the elongate bar 32, such as by a hole extending through the body of the lifting block 10. A pin 38 or collar may be provided to retain the stacking blocks 10 at a desired lateral spacing along the elongate bar 32.

The lifting cradle 30 may be utilized to lift or transport a stacked or a single lattice boom element 18. The elongate bar 32 and attached stacking blocks 10 may be lifted into place on top of the lower lattice boom section 18. Two lifting cradle units 30 are placed on lower boom section 18 creating four points of contact at each of the stacking blocks 10. The stacking blocks 10 will provide enough space between adjacent lattice boom sections 18 to leave the lifting cradle 30 in place. The next boom section 18 will be set on top of the subjacent lattice boom section 18 and secured with ratchet straps 20 for storage and transport of the lattice boom sections 18.

It should be understood, of course, that the foregoing relates to exemplary embodiments of the invention and that modifications may be made without departing from the spirit and scope of the invention as set forth in the following claims.

What is claimed is:

1. A stacking block assembly for supporting a lattice boom element of a lattice boom crane, comprising:
a body formed of a material selected from the group consisting of a plastic, a composite; an elastomer, or a rubber;
a first arcuate channel defined in a bottom surface of the body along a longitudinal length thereof; and
a second arcuate channel defined in a top surface of the body along a longitudinal length thereof.

2. The stacking block assembly of claim 1, wherein the first arcuate channel has a diameter corresponding to a diameter of a vertical support member of a subjacent lattice boom element.

3. The stacking block assembly of claim 1, wherein the second arcuate channel has a diameter corresponding to a diameter of a vertical support member of a superjacent lattice boom element.

4. The stacking block assembly of claim 1, further comprising:
a hole extending transversely through the body between the first arcuate channel and the second arcuate channel.

5. The stacking block assembly of claim 4, further comprising:
an elongate rod having a length corresponding to a width of the lattice boom element, and
the elongate rod received through the hole of a first body and a second body that are carried in a spaced apart relation on the elongate rod corresponding to the width of the lattice boom element.

6. The stacking block assembly of claim 5, further comprising:
a cradle cable extending at a proximal end from each of a first end and a second end of the elongate rod.

7. The stacking block assembly of claim 6, further comprising:
a yoke attached to a distal end of the cradle cable.

8. A method of supporting a lattice boom element of a lattice boom crane, comprising:
providing a stacking block, comprising a body formed of a material selected from the group consisting of a plastic, a composite; an elastomer, or a rubber; a first arcuate channel defined in a bottom surface of the body along a longitudinal length thereof; a second arcuate channel defined in a top surface of the body along a longitudinal length thereof; and
receiving a lower vertical support member of the lattice boom element in the second arcuate channel.

9. The method of claim 8, further comprising:
supporting a bottom surface of the stacking block on a ground surface.

10. The method of claim 8, further comprising:
receiving an upper vertical support member of a subjacent lattice boom element in the first arcuate channel.

11. The method of claim 10 further comprising:
strapping the lattice boom element and the subjacent lattice boom element together.
